(19) United States
(12) Patent Application Publication
(10) Pub. No.: US 2013/0263710 A1
(43) Pub. Date: Oct. 10, 2013

(54) ROOF CUTTER FOR FIREFIGHTING OPERATIONS

(71) Applicant: Lawrence M. Cohen, Suffern, NY (US)

(72) Inventor: Lawrence M. Cohen, Suffern, NY (US)

(21) Appl. No.: 13/754,477

(22) Filed: Jan. 30, 2013

Related U.S. Application Data
(60) Provisional application No. 61/592,079, filed on Jan. 30, 2012.

(51) Int. Cl. A62B 3/00

(52) U.S. Cl. CPC A62B 3/005
USPC 83/13; 30/389

(57) ABSTRACT

A device is provided for venting a burning structure by cutting an opening in the roof the burning structure. The device may comprise an elongated shaft or pole with a power means and blade means at opposite ends or the same end thereof, and a drive means for conveying power from the power means to the blade means, and an actuator means for moving the blade means in at least one plane with respect to the shaft or pole.

This application claims priority under 35 USC §119(e) to U.S. Provisional Patent Application Ser. No. 61/592,079, filed Jan. 30, 2012, the entire contents of which are hereby incorporated by reference.

The present invention relates generally to a device for use in emergency and rescue operations, and in particular firefighting, which enables a worker to make a cut in a building façade or roof from a distance. In particular, the invention relates to a cutting device having a handle or gripping portion at or adjacent to one end and a cutting or blade means at or adjacent to an opposite end, the handle and blade means being separated by an elongate spacer or pole of sufficient length to permit a firefighter to stand in the bucket of a fire truck or other point of safety and reach the roof of a building with the blade means so as to make a cut in the roof or other façade to vent flames and smoke, the blade means preferably being moveable along at least on plane, and preferably along at least two planes, by operation of an actuator by the user.

When extinguishing a building fire, fire fighters vertically vent the fire area by cutting holes through the roof of the building. Traditionally, this procedure has required fire fighters to stand on the roof of the burning building so that they can access and cut through the roof by hand. This process is extremely dangerous at least because roofs of burning buildings are susceptible to collapsing, in whole or in part, as a result of the fire. Such a collapse may severely injure or kill firefighters who were standing on the roof prior to the collapse. Therefore, a need exists in the art for a safer means for cutting roofs of burning buildings.

This and other needs are met by the present invention which provides a device for use in firefighting to enable a firefighter to cut an aperture in the roof of a building to vent the flames and smoke from a safe distance (such as on a fire truck or other mobile platform) without the need to crawl onto the roof. In one aspect, the invention provides a cutting device having a handle or gripping portion at or adjacent to one end and a cutting or blade means at or adjacent to an opposite end, the handle and blade means being separated by an elongated spacer or pole of sufficient length (e.g., between about 2 feet and about 32 feet, or between about 4 feet and about 12 feet, etc.) to permit a firefighter to stand in the bucket of a fire truck or other point of safety and reach the roof of a building with the blade means so as to make a cut in the roof or other façade to vent flames and smoke. The blade means is preferably moveable along at least on plane, for example, the tip of the blade may be moveable in an arc, preferably about a vertical plane with respect to a standing user. Alternatively, the blade means may be moveable from left to right with respect to a standing user, so that the tip of the place traces a horizontal arc. In other embodiments, the blade is moveable in at least two planes, for example, both vertically and horizontally. This degrees of freedom permit a user to cut a hole in a roof from a substantially stationary position, i.e., without needing to move to different sides of the hold to make cuts. The device includes an actuator that permits the user to adjust the blade position along the at least one planes. The blade means may include a series of gears or the like to adjust the movement and angle and to lock the blade in position when the desired angle is reached. FIG. 1 illustrates an extendable power device 100, in accordance with certain exemplary embodiments.

In certain exemplary embodiments, the extendable device is powered by a power means 100 which may include a motor 105, which actuates one or more blade means 110 coupled to a drive means 115. The power means 105 includes any device that converts energy into mechanical energy. For example, power means 105 may be a motor that may be gas powered, hydraulic, pneumatic, or electric in certain exemplary embodiments. The motor may comprise, for example, a two stroke internal combustion engine, including without limitation, those with a cylinder volume of 30-120 cm³. In other embodiments, a four stroke internal combustion engine is contemplated. Alternatively, a hybrid four stroke engine of the type made by Stihl (4MIX technology) is also contemplated. The power means may be located either at the proximal end of the tool, i.e., at or near the end that is gripped by the user, or the power means may be at or closer to the distal end of the device, i.e., near the blade means. The drive means may comprise a drive shaft, including without limitation a straight drive shaft or a curved drive shaft, a belt drive, or the like.

The saw blade means may be any blade or like implement capable of rapidly cutting through typical roofing materials (shingle, wood, etc.). For example, the saw blade means may comprise a circular saw blade having teeth disposed around the periphery, including without limitation, a circular saw blade, a Strob saw blade, a plytooth blade, a Dado blade, a brush cutter blade, a cold saw blade, and the like. In some embodiments, the saw blade means may not comprise teeth but rather comprise an abrasive-type blade such as those used for cutting metal, including without limitation, abrasive saws, metal chop saws, and cut-off saws. In other examples, the saw blade means may comprise a chain saw blade, and the like, which typically will comprise an elongated guide bar having an edge slot for receiving and guiding a chain. The bar may be, for example, between 12 inches and 30 inches or longer in length. The chain will often comprise riveted metal sections having small sharp cutting teeth in the form of a folded tab of chromium plated steel or the like with a sharp angular or curved corner and two cutting edges, one on the top plate and one on the side plate. The chain may be, for example, a full complement chain having teeth on every other drive link, or it may be a full skip chain with one tooth on every third drive link, or the like. The intervening drive links may comprise a raker to adjust the depth of the cut. The chain edge may optionally be embedded with diamond grit to aid in cutting through brick, concrete and other non-fibrous substrates. In other embodiments, the blade means may comprise a reciprocating or oscillating saw.

Each saw blade 110 preferably includes a material that is able to withstand extreme heat, including flame impingement, and abuse of cutting structural components that make up a roof. For example, the saw blade 110 or teeth may be composed of, coated with, capped with or otherwise comprise carbide metals, such as tungsten carbide, or may comprise diamond. In other embodiments, the blade or teeth may be composed of, coated with, capped with or otherwise comprise high speed steel (HSS), including cobalt HSS.

In certain exemplary embodiments, each saw blade 110 is rotatable around at least part of a plane 120 perpendicular to a longitudinal axis of the drive means 115. The drive means 115 ay be, without limitation, a straight drive shaft which rotates about its longitudinal axis, a curved brive shafted, for example, consisting of two or more straight segments, a belt drive, a chain drive, or the like. For example, as depicted in FIG. 1 above, each saw blade 110 may rotate up to 180 degree or more, between positions A-D. In certain alternative exemplary embodiments, each saw blade 110 may rotate up to 360 degrees, as depicted in FIG. 2 below. The device 100 may include one or more depth gauges to limit the depth of each blade's cuts.

The device 100 may include a actuator means, such as a manual or automated lever or adjusting mechanism, which allows the firefighter to adjust the angle of the blade(s) 110, in a single plane (as illustrated above) and/or in a right-and-left angular movement, or in two or more planes. The blade(s) 110 may be in a static, rest mode, or a dynamic, operational mode during this adjustment. In certain exemplary embodiments, the mechanism includes a locking means, such a locking gears, which allows the firefighter to manually or automatically lock the blade(s) 110 in a desired position.

The length of the spacer or pole is typically between about 2 feet and about 32 feet, including between 2-5 feet, 5-10 feet, 10-15 feet, 15-20 feet, or 11-12 feet, or longer. In certain exemplary embodiments, the drive shaft 115 has a static or adjustable length, which allows the operating firefighter to stand a safe distance away from the building while using the device 100 to cut through the building's roof. For example, depending upon engineering recommendations related to strength of the drive shaft 115, the drive shaft 115 may extend between about ten and twelve feet. For example, the drive shaft 115 may include one or more telescoping members, which extend to allow the firefighter to remotely access and cut through the roof of the building. For example, the firefighter may utilize the device 100 while standing on a tower ladder or portable ladder, which is adjacent or proximate to the building. In certain exemplary embodiments, the drive shaft 115 includes a material that is able to withstand extreme heat, including flame impingement. This material may be the same as or different than the material(s) of the saw blade 110.

Thus, the device 100 provides a safe means for a firefighter to cut vents in roofs of burning buildings. This means may significantly reduce injuries and fatalities involving roofs in firefighting operations.

The device according to the invention may be distinguished from a conventional pole saw in that the power means typically provides significantly more power than a pole saw, which usually has a 1.5 HP motor. The device of the present invention is driven by a power means that may provide, for example, more than 2.5, more than 3, more than 4, or between 4.5 and 6.5 bhp, or more of power. Also, the blade in the present device is rotatable about at least one plane, preferably at least two planes, and is optimally adapted to withstand the rigors of high temperature and flames found encountered in firefighting, which are features not found in conventional pole saws.

Many modifications of the embodiments depicted and described herein will be apparent to one of skill in the art having the benefit of the present disclosure. Therefore, it is to be understood that the invention is not to be limited to the specific embodiments disclosed and that modifications and other embodiments are intended to be included within the scope of this application. Although specific terms are employed herein, they are used in a generic and descriptive sense only and not for purposes of limitation.

### BRIEF DESCRIPTION OF THE DRAWINGS

FIG. 1 is a top view of one embodiment of the extendable power device 100 and an enlarged view of a drive shaft 115 according to the present invention.

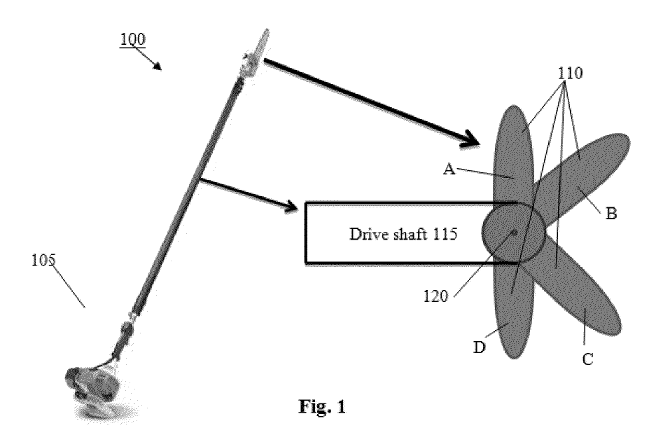

FIG. 2 illustrates one embodiment of saw blade 110 according to the present invention.

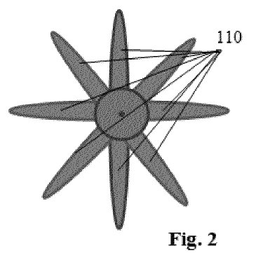

What is claimed is:

1. A device for cutting a roof of a burning building, comprising:
an elongated drive shaft comprising a first end and a second end;
a motor coupled to the first end of the elongated drive shaft;
at least one blade coupled to the second end of the elongated drive shaft, the motor operable to actuate each blade to cut roofing material in a burning building, each blade comprising a material designed to withstand flame impingement.

2. The device of claim 1, wherein the elongated drive shaft includes telescoping members, which are actuatable to adjust a length of the elongated drive shaft.

3. The device of claim 1, wherein each blade is rotatable around at least part of a plane perpendicular to a longitudinal axis of the drive shaft.

4. The device of claim 3, wherein each blade is rotatable at least 180 degrees around the plane perpendicular to the longitudinal axis of the drive shaft.

5. The device of claim 3, wherein each blade is rotatable 360 degrees around the plane perpendicular to the longitudinal axis of the drive shaft.

6. A device for cutting a roof of a burning building, comprising:
an elongated shaft or pole having a length between 3 feet and 32 feet, a first end and a second end;
a power means located at or adjacent to the first end of the elongated shaft or pole for driving a blade means;
a blade means at or adjacent to the second end of the elongated drive shaft which is powered by said power means through a drive means,
an actuator means for moving the blade means in at least one plane with respect to the shaft or pole;
and a locking means for locking the place in a fixed orientation with repsect to the shaft or pole;
wherein the blade means is capable of cutting through roofing materials.

7. The device according to claim 6, wherein said power means is a two stroke or 4-stroke internal combustion engine that generates at least about 4 bhp.

8. The device according to claim 6, wherein said blade means comprises a chain saw.

9. The device according to claim 6, wherein said shaft is between about 4 and about 12 feet long.

10. The device according to claim 6, wherein said shaft is telescoping.

11. The device according to claim 6, wherein said drive means are substantially contained within said shaft or pole.

12. A method of venting a burning structure comprising cutting an opening in said structure using the device of claim 11, wherein a firefighter operates said device from a location distant from said structure.
